(19) United States
(12) Patent Application Publication
(10) Pub. No.: US 2026/0258568 A1
(43) Pub. Date: Sep. 3, 2026

(54) A CAPPING BOARD INCLUDING SIDE WALL PORTIONS FOR PREVENTING METAL DUST RELEASE DURING ELECTROREFINING

(71) Applicant: PULTRUSION TECHNIQUE INC., Saint-Bruno-de-Montaville (CA)

(72) Inventor: Robert Dufresne, Saint-Bruno-de-Montaville (CA)

(21) Appl. No.: 18/879,593

(22) PCT Filed: Jun. 27, 2023
(86) PCT No.: PCT/CA2023/050886

§ 371 Date: Dec. 27, 2024

Related U.S. Application Data
(60) Provisional application No. 63/367,087, filed on Jun. 27, 2022.

(51) Int. Cl. C25C 7/00

(52) U.S. Cl. CPC C25C 7/00

(57) ABSTRACT

A capping board is provided for electrorefining metals in two adjacent electrolytic cells. The capping board is configured for use with a contact bar and includes a main elongated body made of an electrically insulating material having a plurality of seats projecting upwardly and being distributed along side portions of the main elongated body in two opposed rows to define a central portion extending in a longitudinal direction of the main elongated body between the two rows of seats, and multiple lateral portions extending in a transverse direction of the main elongated body in between seats of a same row. The main elongated body further defines side wall portions projecting upwardly between seats of a same row and from side edges of the main elongated body, thereby preventing metal dust being generated by the contact bar from being communicated to the adjacent electrolytic cells via the lateral portions.

### TECHNICAL FIELD

The present techniques generally relate to the electrorefining of metals in electrolytic cells and, more particularly, to a capping board including side wall portions being sized to prevent metal dust that is generated by a contact bar from being propagated to the adjacent electrolytic cells.

### BACKGROUND

In the hydrometallurgical industry, it is of common practice to refine metal by electrolysis in electrolytic cells especially designed for this purpose. The metals to be refined are usually conventional metals such as copper, zinc, nickel, thin, cobalt or cadmium, or precious metals such as silver, platinum or gold, rare earths and others.

Usually, the metal to be refined, or the metal used to carry the electric current, is in the form of electrode plates of a given thickness. In use, the electrode plates are immersed in an electrolytic bath into the cells in parallel relationship and are used as anodes, cathodes or both, depending on the affinity of the metal being refined.

It has been of common practice to use capping boards and contact bars to selectively insulate and conduct current between electrode plates of adjacent cells. However, the contact bars are made of metal, e.g., copper, which can easily wear and can produce metal dust during operation, handling and maintenance of the cells. Such metal dust particles can reach the electrolytic bath and hinder the purity of the metal to be refined, e.g., zinc.

Various challenges related to dust control in electrolytic refining of metals remain to be overcome.

### SUMMARY

Implementations of the capping board have been developed to reduce the amount of impurities that can reach the electrolytic bath by propagation from the capping board.

In one aspect, there is provided a capping board configured for use with a contact bar lying on the capping board for electrorefining of metals in two adjacent electrolytic cells. The capping board includes a main elongated body made of an electrically insulating material having:
a plurality of seats projecting upwardly and being distributed along side portions of the main elongated body in two opposed rows to define:
   a central portion extending in a longitudinal direction of the main elongated body between the two rows of seats, and
   multiple lateral portions extending in a transverse direction of the main elongated body in between seats of a same row; and
side wall portions projecting upwardly between seats of a same row and from side edges of the main elongated body, wherein the side wall portions prevent metal dust that is generated by the contact bar from being communicated to the adjacent electrolytic cells via the lateral portions.

In some implementations, the capping board further includes a pair of gutters, each gutter being a recess extending along and below a side of the central portion of the main elongated body between the two rows of seats, to guide rinsing water away from the capping board. For example, each gutter can have a depth that varies in the longitudinal direction to create a slope towards at least one end portion of the capping board. Optionally, the depth of each gutter can increase from a middle of the capping board to each end portion of the capping board to create a tapered bottom surface for each gutter. Further optionally, the depth of each gutter can increase from a proximal end portion to a distal end portion of the capping board to create a downwardly inclined bottom surface for each gutter.

In some implementations, each of the multiple lateral portions of the main elongated body can be sloped towards the corresponding gutter to guide the water from the side wall portions, along the lateral portions and to the gutter.

In some implementations, the capping board further includes a water bridge component extending from the gutters of the main elongated body to guide the rinsing water across a side wall of the electrolytic cells to a dedicate collection area. For example, the water bridge component can include one water bridge collecting the rinsing water being evacuated from the gutter and directing the evacuated rinsing water to the dedicated collection area. In another example, the water bridge component can include a pair of water bridges, each water bridge collecting the rinsing water being evacuated from one corresponding gutter and directing the evacuated rinsing water to the dedicated collection area.

In some implementations, the capping board can include a plurality of longitudinal walls segments distributed as two opposed inner rows and projecting upwardly from each side of the central portion of the main elongated body to provide abutment for the contact bar when lying on the central portion. Optionally, the capping board can include a groove defined in the central portion of the main elongated body and along a base of each longitudinal wall segment to facilitate flowing of the rinsing water from the central portion towards the corresponding longitudinal gutter.

In some implementations, the capping board can include reinforcement elements that are embedded in the main elongated body. For example, the reinforcement elements can be made of pultruded material.

In another aspect, there is provided a system for the electrorefining of metal in two adjacent electrolytic cells. The system includes:
a capping board as defined herein;
a contact bar lying on the central portion of the capping board;
multiple electrodes comprising an electrode plate and a pair of hanging bars extending from each upper side of the electrode plate, with the hanging bars being sized to be alternately received on the contact bar or on one corresponding seat of the capping board;
a source of water to provide a flow of water to the central portion and the lateral portions of the capping board to form rinsing water comprising metal dust; and
a dedicated collection area comprising a collection tank sized to receive the rinsing water being evacuated from the capping board.

In some implementations, the contact bar can be provided as multiple contact bar segments and the central channel of the caping board can be configured to receive at least one row of the contact bar segments.

In some implementations, the contact bar can be a primary contact bar and the capping board has the central channel that is configured to receive the primary contact bar, and the system can further include an additional insulating body and at least one additional contact element, with the additional insulating body and the at least one additional contact element being configured to cooperate with a symmetrical electrode arrangement.

While the present capping board and related system will be described in conjunction with example embodiments and implementations, it will be understood that it is not intended to limit their scope to such embodiments or implementations. On the contrary, it is intended to cover all alternatives, modifications and equivalents as may be included as defined by the present description. The objects, advantages and other features of the present capping board and related system will become more apparent and be better understood upon reading of the following non-restrictive description of the invention, given with reference to the accompanying drawings.

### BRIEF DESCRIPTION OF THE DRAWINGS

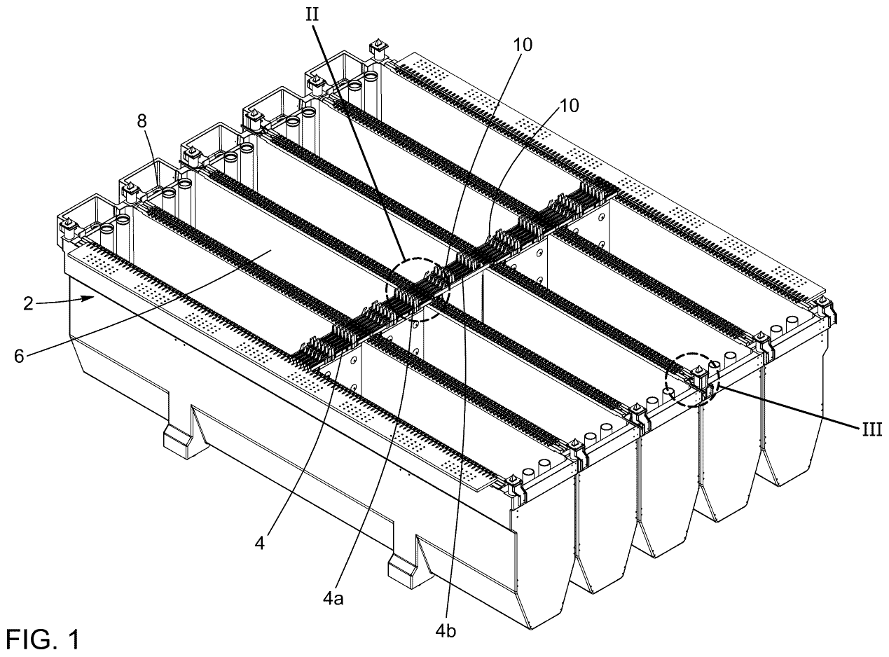

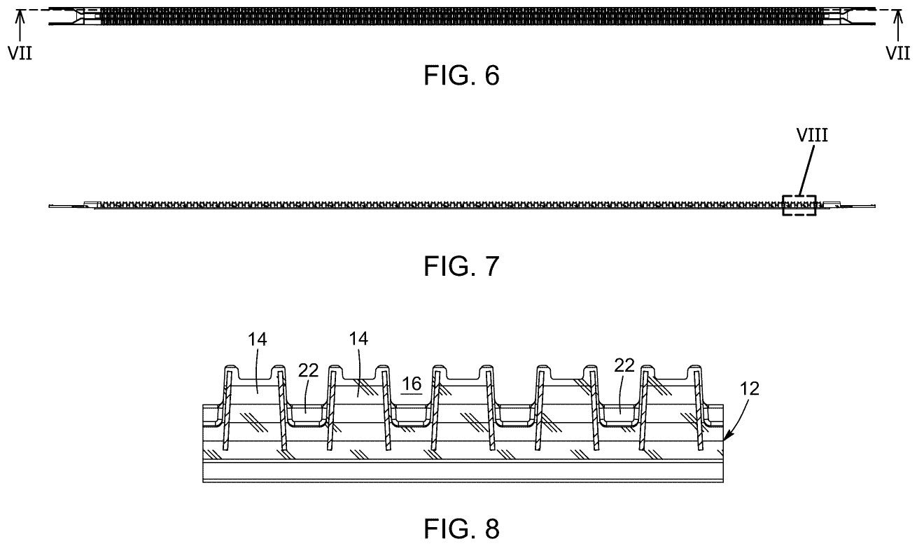

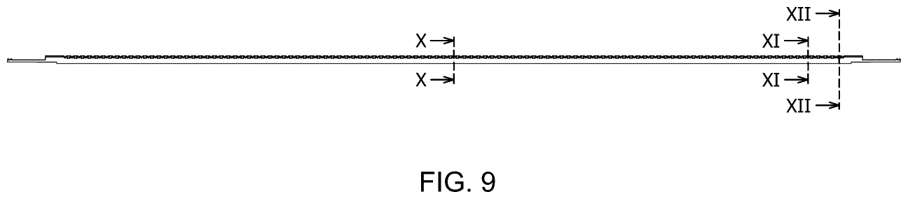

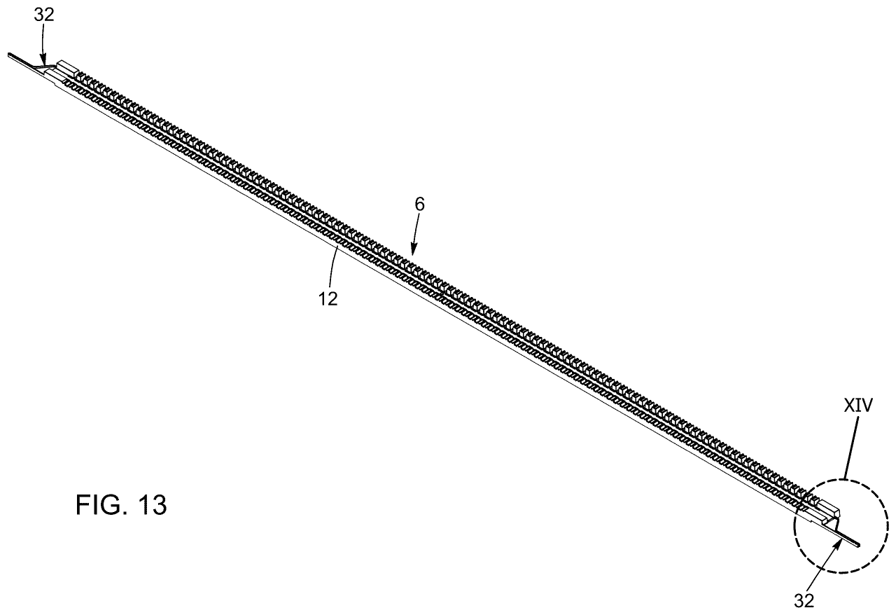

Implementations of the capping board are represented in and will be further understood in connection with FIGS. 1 to 14.

Numerical references are assigned to the following elements:

| | |
|---|---|
| Electrolytic cell | 2 |
| Electrode plate | 4 |
| (cathode or anode) | |
| Capping board | 6 |
| Contact bar | 8 |
| Hanging bar | 10 |
| Main elongated body | 12 |
| (Insulating) Seat | 14 |
| Lateral channel | 16 |
| Central channel | 18 |
| Central portion | 20 |
| Side wall portion | 22 |
| Gutter | 24 (bottom surface |
| | thereof 240) |
| Sloped lateral surface | 26 |
| Inner side wall (segment) | 28 |
| Reinforcement component | 30 |
| Water bridge component | 32 |
| Water bridge | 34 |
| Groove | 36, 36a, 36b |

While the invention will be described in conjunction with example embodiments, it will be understood that it is not intended to limit the scope of the invention to these embodiments.

### DETAILED DESCRIPTION

There is provided a capping board for use in connection with two adjacent electrolytic cells, a contact bar and multiple hanging bars of anodes and cathodes mounted within each electrolytic cell. The present capping board is designed to reduce or avoid contamination of the electrolytic cell with metal dust produced from the contact bar lying on the capping board.

FIG. 1 illustrates five adjacent electrolytic cells 2, each cell 2 is being shown with a few electrode plates 4 being inserted therein. Referring to FIG. 1, in order to have the electrode plates 4 positioned in a precise location along walls of each cell 2, there is provided a component called the “capping board” 6 or a “bus bar insulator” onto the top surface of each lateral sidewall of the cells 2. These capping boards 6 are used to position the plates 4 with respect to each other along an interior of the cells 2. The capping boards 6 are also used as electric insulators between adjacent cells 2 and/or the electrode plates 4 and/or the ground.

Still referring to FIG. 1, each capping board 6 is further used in combination with an electrically conductive contact bar 8, the purpose of which being to selectively allow electrical connection between the ends of the cathodes and anodes (electrode plates 4a and 4b) located in adjacent cells 2. Thus, the combined use of capping boards and contact bars allows both insulation and distribution of electric current. Still referring to FIG. 1, to achieve proper electrical contact with the contact bar 8, each electrode plate 4 is provided at an upper end thereof with two laterally extending projections 10, called hanging bars. Such hanging bars 10 facilitate gripping, handling and hanging of the plate 4 on lateral sidewalls of the cells 2. Only one end of the hanging bars 10 of each plate 4 is in contact with a contact bar 8 on one side of the cell 2 where it is located. The other end of the bar 10 of the same plate 4 is held on to the capping board 6 located on the opposite side of the cell 2 in such a way as to be insulated.

Thus, the capping board plays the role of an insulator and is made of insulating material. The contact bar usually extends over the full length of the corresponding capping board in order to connect altogether all the anodes of one cell to all the cathodes of the adjacent cell and vice versa. The contact bar may interconnect all of the cathodes to the anodes on other adjacent cells or perform other electric connection function between electrodes as desired. The contact bar is made of electrically conductive metal, such as copper or aluminum, that can produce dust upon wearing.

The present capping board is configured to collect the produced metal dust and allow evacuation of this dust away from the electrolytic cell, thereby avoiding contamination of the electrolytic bath with potential impurities. Metal dust should be understood herein as metal particles separating from the contact bar upon attrition of the contact bar, or from any metal part supported by the contact bar or the insulator (such as metal portions of the hanging bars, for example).

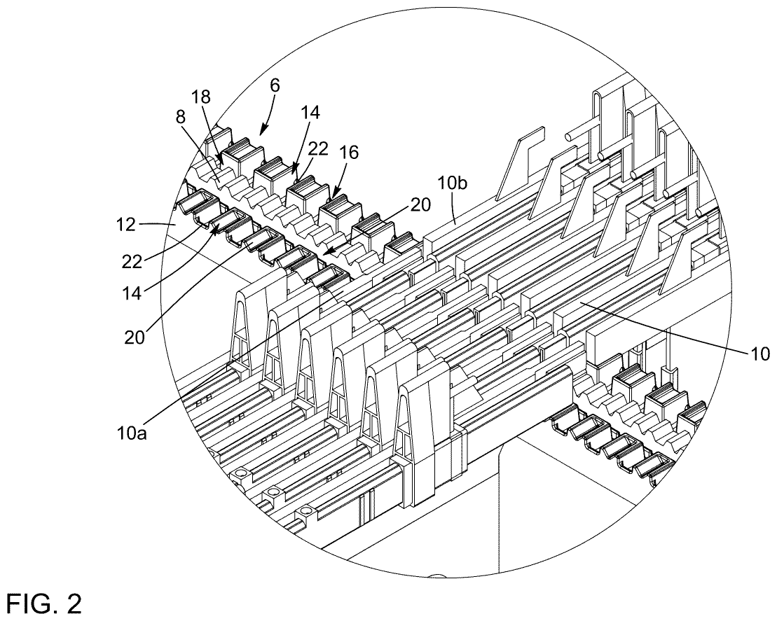

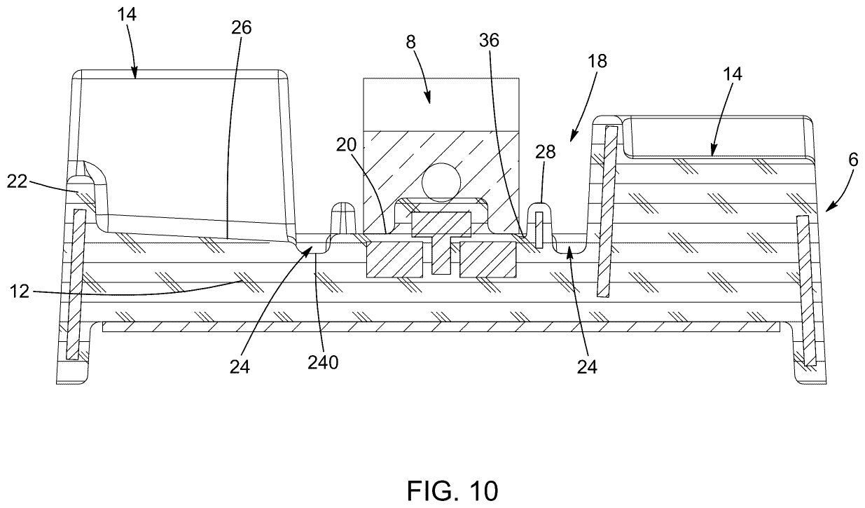

Referring to FIG. 2, the capping board 6 includes a main elongated body 12 defining a one-piece structure being sized and shaped to support the contact bar 8 when positioned in a longitudinal direction of the main elongated body 12, and the hanging bars 10 of the electrode plates 4 when positioned in a transverse direction of the main elongated body 12. More particularly, referring to FIGS. 10 to 12, the main elongated body 12 of the capping board 6 defines a plurality of seats 14 that are distributed along the main elongated body in two opposed rows being in a staggered/offset relation to each other. Referring to FIG. 10, each of the first and second rows of seats 14 is spaced apart from the opposed row of seats to define a central channel 18 extending along the longitudinal direction of the main elongated body 12. The central channel 18 is sized to accommodate the positioning of the contact bar 8 lying on a central portion 20 of the main elongated body 12 and within the central channel 18 of the capping board 6.

The longitudinal direction refers herein to a direction/axis along the length of the capping board, whereas the transverse direction refers to a direction/axis along a width of the capping board (and perpendicular to the longitudinal direction). A transverse plane is thus a vertical plane oriented in the transverse direction and a longitudinal plane is thus a vertical plane oriented in the longitudinal direction.

Still referring to FIG. 2, each seat 14 extends upwardly and is spaced apart from an adjacent seat 14 of the same row to define a lateral channel 16 along the transverse direction of the main elongated body 12. The lateral channel 16 allows passage for a corresponding hanging bar 10a of the electrode plates from the electrolytic cell, allowing access to the contact bar 8 lying within the central channel 18. Each of the seats 14 provides support for another corresponding hanging bar 10b of the electrode plates 4 to sit in a depression 20 defined in an upper surface of each seat 14.

The size and configuration of the seats of the first row can differ from the size and configuration of the seats of the opposed second row, but it should be understood that the seats of the first row and the seats of the second row may be similar.

The capping board further includes side wall portions extending between the seats of a same row to prevent any metal dust that is generated in the central channel from being communicated to the electrolytic bath of the cell through the lateral channels of the capping board. Referring to FIG. 8, the main elongated body 12 further defines the side wall portions 22 extending upwardly between seats 14 of each row and from side edges of the main elongated body 12. Referring to FIG. 2, each side wall portion 22 is sized to allow the insertion of a corresponding hanging bar 10 in the lateral channel 16, and to avoid contact between the hanging bar 10 and the side wall portion 22 when the hanging bar 10 is supported by the contact bar 8. For example, the side wall portion can be sized and configured such that a gap of at least 2 mm is present between a top edge of each side wall portions and a corresponding hanging bar when the hanging bar is supported by the contact bar). Optionally, the side wall portion is spaced from the hanging bar when the hanging bar is supported by the contact bar, optionally by a distance of at least 5 mm.

To prevent accumulation of the metal dust in the central channel and lateral channels of the capping board, the capping board can be rinsed with rinsing water. Optionally, the rinsing water can be or include distilled water. The rinsing can be performed periodically and in accordance with a frequency at which the metal is collected from the electrolytic cell. The present capping board is thus configured to allow evacuation of the rinsing water from the central channel. For example, the capping board can have a sloped/tapered surface allowing the rinsing water to flow away from the capping board and towards a dedicated collection area.

For example, referring to FIG. 10, the capping board 6 can include a pair of gutters 24 allowing the rinsing water to flow along the gutters 24 towards at least one end of the capping board 6. Each gutter 24 is defined as a recess in the main elongated body 12 of the capping board 6, and each of the two gutters 24 extending along and below a side edge of the central portion 20 of the main elongated body 12.

To enhance drainage of the rinsing water, the gutter can be a sloped gutter having a depth that varies in the longitudinal direction. The gutter can thus have a bottom surface being sloped at an angle allowing the rinsing water to flow towards the dedicated collection area.

In some implementations, the bottom surface of the gutters can be downwardly sloped from a distal end to a proximal end of the main elongated body, such that the rinsing water flows away from the capping board via the proximal end thereof. However, it should be noted that the slope of the bottom surface of one gutter can be reversed with respect to the opposed gutter such that the rinsing water can flow away from both distal and proximal ends of the capping board. Optionally, the bottom surface of each gutter can be sloped at an angle between 0.025° and 5°, corresponding to a variation (from one end to the opposed end of the capping board) in the depth of the gutters from 12 mm to 15 mm.

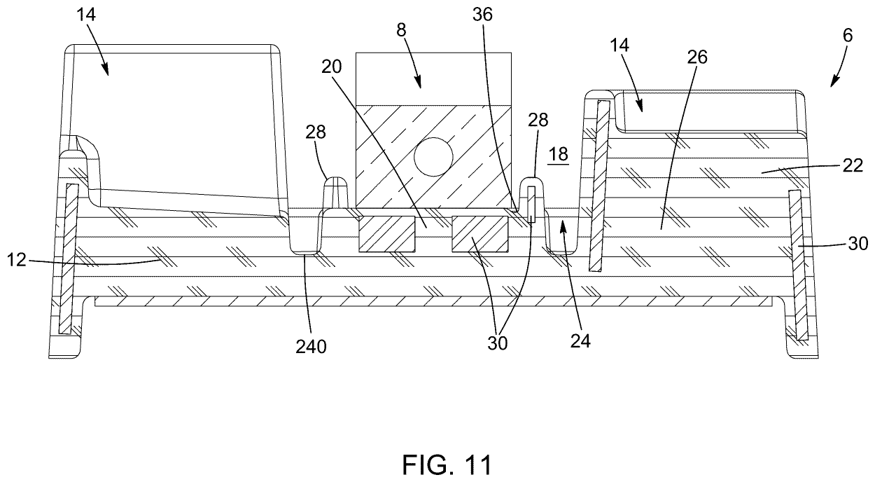

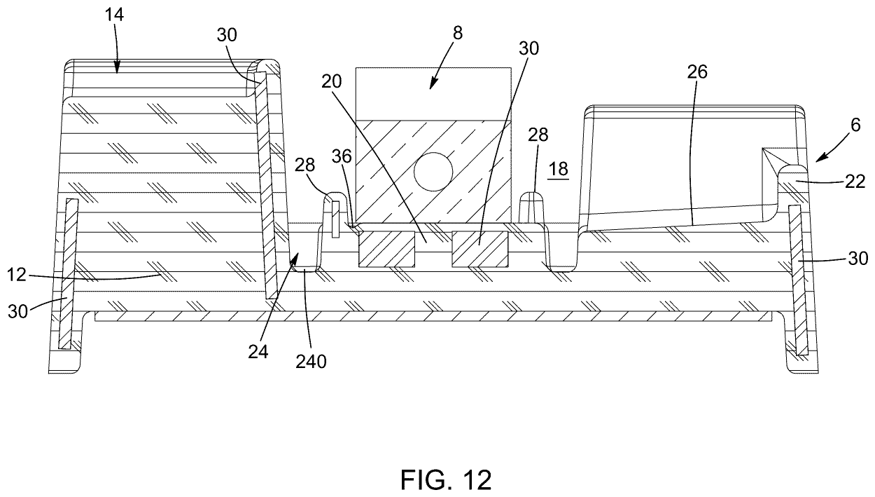

In some other implementations, referring to FIGS. 10 to 12, the capping board 6 can be configured to be symmetrical with respect to a central transverse plane (FIG. 10). The bottom surface of each gutter 24 can be tapered to define two downwardly sloped portions extending from a middle of the gutter 24 (FIG. 10) to an end of the gutter (FIG. 12), such that the rinsing water can flow away from both distal end and proximal end of the capping board 6. In other words, the depth of each gutter 24 can increase from the middle of the gutter to each end of the gutter. FIG. 10 provides a cross-sectional view of a middle portion of the capping board 6, and the gutters 24 are shown to have a lower depth in this middle portion than in an end portion of the capping board, as seen the cross-sectional views of FIGS. 11 and 12. Optionally, each sloped portion can be downwardly inclined at an angle between 0.025° and 5° (with respect to a horizontal plane).

To further enhance evacuation of the rinsing water and to avoid stagnation thereof, the capping board can have lateral surfaces that are downwardly sloped towards a corresponding gutter to guide the rinsing water to the gutter and away from the capping board via the gutter. For example, still referring to FIGS. 10 to 12, the capping board 2 can include sloped lateral surfaces 26 corresponding to top surface portions of the main elongated body 12 that are found in between seats 14 of a same row. These sloped lateral surfaces 26 are downwardly inclined so that the rinsing water can flow from the side wall portions 22, along the sloped lateral surfaces 26, and down to the adjacent gutter 24 within the central channel 18 of the capping board 6. Optionally, the sloped lateral surfaces between seats of a same row are inclined at an angle between 0.025° and 5°. Optionally, the slope of one sloped lateral surface can differ from the one of the opposed sloped lateral surface.

It should be noted that the angle of the sloped surfaces of the capping board can be selected in accordance with a width and a length of the capping board to ensure that the rinsing water is efficiently evacuated from the side wall portions to a corresponding adjacent gutter, from the middle of the capping board to each end of the capping board, or from one end of the capping board to the other end of the capping board.

In some implementations, as seen in FIGS. 10 to 12, the capping board 6 can further include a plurality of longitudinal walls or wall segments 28 projecting upwardly along sides of the central portion 20 of the main elongated body 12 to provide abutment for the contact bar 8 lying on the central portion 20 and to avoid movement of the contact bar 8 towards the side gutters 24. The longitudinal wall segments 28 are distributed as two opposed inner rows, with the rows of wall segments 28 being for example symmetrical with respect to a central longitudinal plane of the capping board 6.

Optionally, a groove can be provided in the central portion of the main elongated body at a base of each longitudinal wall segment to facilitate flowing of the rinsing water from the central portion towards the corresponding longitudinal gutter. More particularly, referring to FIG. 11, the rinsing water received by the central portion 20 can be collected in the grooves 36 that are positioned at the base of each longitudinal wall segment 28, and can be communicated to the corresponding longitudinal gutter 24 by flowing from the groove 36 and in between longitudinal wall segments down to the corresponding longitudinal gutter 24.

The main elongated body is made of an insulating material. In some implementations, the main elongated body can be formed of resin consisting of polytetrafluoroethylene, polyester, polyurethanes, vinylester, epoxy, epoxy bisphenol F, bisphenol fumarate, polyphenylene sulphide-based and phenolic resins, and blends or alloys of the same.

In some implementations, the capping board can further include reinforcement elements that are embedded in the main elongated body. The reinforcement elements can be pultruded elements obtained by pultrusion of fibers comprising glass fibers, sisal fibers, resin fibers or any combinations thereof, impregnated with a resin consisting of polyester, vinyl ester, epoxy, polyurethane, thermoset urethane, bisphenol-epoxy A-F fumarate polyester series, acrylic, methacrylic, terephthalate polyester, phenol, or any mixtures thereof. The pultruded elements can be further coated with a surface layer of a resin bonding agent being before being embedded in the main elongated body of the capping board. Referring to FIG. 11, the reinforcement elements 30 can be found in the side wall portions, in the central portion below the contact bar, in the central portion along the gutters, in seats of the main elongated body, or any combinations thereof. The number, shape and size of the reinforcement elements can vary depending on the level of reinforcement needed. The reinforcement elements can extend over a full length of the capping board or be provided as segments within the main elongated body.

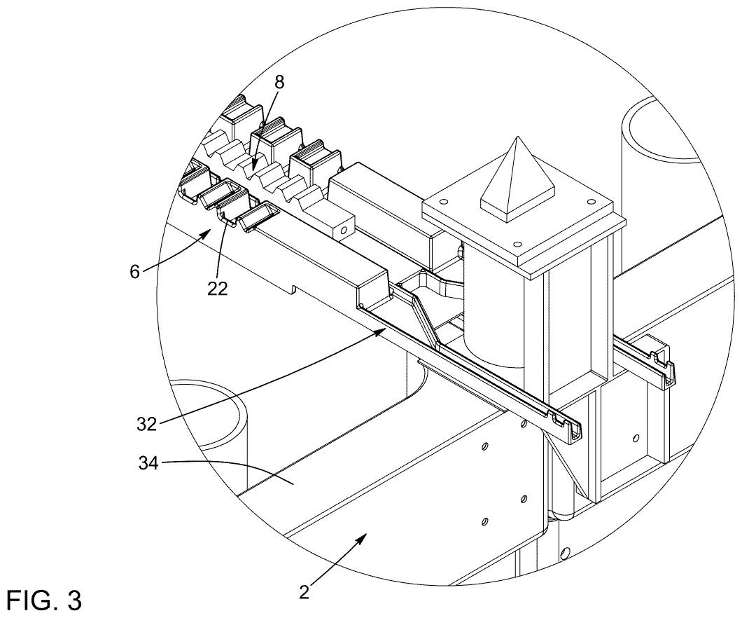

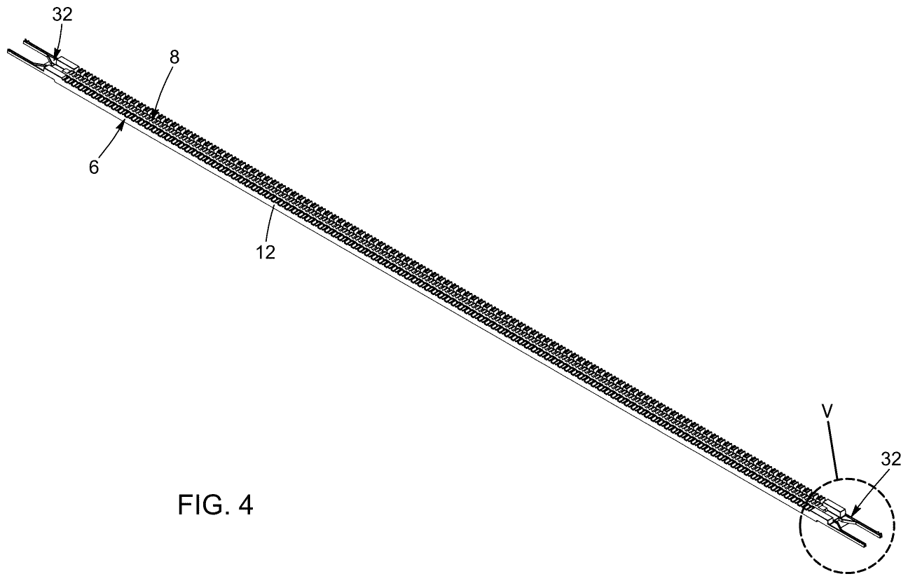

In some implementations, the capping board further includes a water bridge component extending from at least one end of the main elongated body and being in fluid communication with at least one gutter of the pair of gutters. As better seen in FIG. 3, the water bridge component 32 can be positioned across a side wall 34 of the electrolytic cell 2 to direct the rinsing water from the gutters to the dedicated collection area (not shown) that is located outside of the electrolytic cell 2. Referring to FIGS. 4 and 10, the water bridge component 32 can be provided at both ends of the main elongated body 12. This configuration is suitable when rinsing water can be evacuated from both ends of the capping board 6. Alternatively, for example, if the gutters are sloped from one end of the main elongated body down to the other end of the main elongated body, the water bridge component can be provided only at one end of the main elongated body to collect the flowing rinsing water. It should be noted that the water bridge component can be part of the main elongated body as a one-piece structure (as seen in the Figures) or could be provided as a separate component that is connectable to at least one end of the main elongated body to be in fluid communication with the gutters within the central channel.

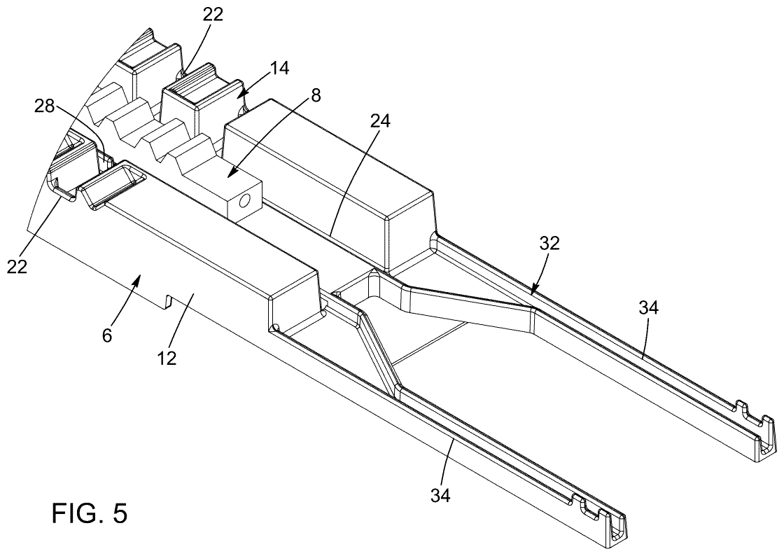

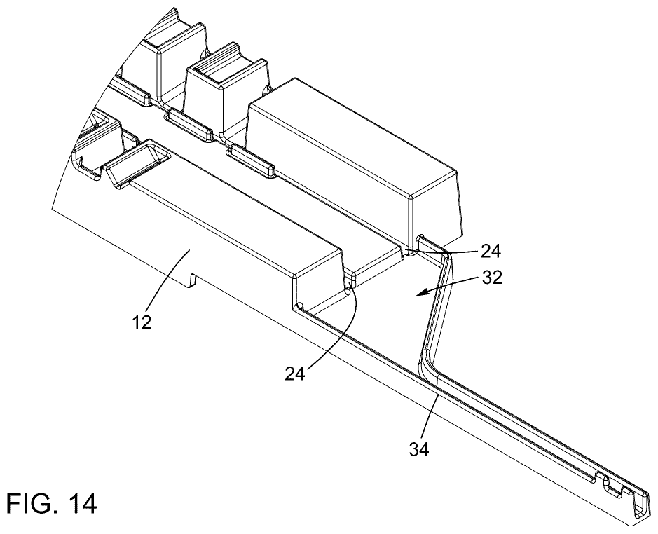

Referring to FIG. 5, the water bridge component 32 can include two water bridges 34, with each water bridge extending from the side portions of the main elongated body 12 for collecting the rinsing water flowing from the corresponding gutter 24. Referring to FIG. 14, the water bridge component 32 can rather include a single water bridge 34 extending from at least both gutters 24 of the main elongated body 12 for collecting the rinsing water flowing simultaneously from the pair of gutters 24.

One skilled in the art will readily understand how to modify the number of the water bridge components and the number and design of the water bridges in accordance with the slope of the gutters. In addition, the design of each water bridge can vary to accommodate elements that can be encountered above side walls of the electrolytic cell. For example, the number of water bridges of each water bridge component can vary, and the width of each water bridge can be narrowed as seen in FIG. 14 or 5, to direct the rinsing water around upstanding elements of the electrolytic cell.

There is provided herein a system including the capping board as described herein and the dedicated collection area that is located generally below the capping board to collect the rinsing water being guided through the gutters of the capping board. For example, the dedicated collection area can be defined by a collection tank having an open top to receive the rinsing water falling down the water bridge component of the capping board via the open top and inside the collection tank. The collection tank can be secured to an external surface of a corresponding side wall of the electrolytic cell, and below an end portion of the water bridge(s) of the water bridge component. It should be noted that the collection tank can be connectable to a piping network allowing removal and optional treatment of the metal-enriched collected rinsing water. Alternatively, the dedicated collection area can be a piping network directly connected to the gutters or bridge components. Alternatively, the rinsing water can be guided out of the electrolytic cell via the bridge component(s) to fall down to the floor of the facility where the rinsing water can be evacuated to a remote dedicated collection area.

The capping board as described herein may take on a variety of forms and sizes according to the desired application as well as the specifications of the electrode plates and cells with which they are used. When assembled, the present invention may have the form and function of various types of capping boards known in the art, some of which are described herein and illustrated in the Figures. For example, the particular arrangement of the central and lateral channels and/or the seats may be adapted according to the positioning of other elements, such as the electrode plates, the type of contact bar, etc.

In hydrometallurgical refining of metals, there are two main configurations that may be used to support the electrodes: symmetrical configurations using symmetrical anodes and cathodes and asymmetrical configurations using asymmetrical anodes and cathodes. Implementations of the capping board as described herein can be adapted depending on the type of electrodes to be used. For example, the Figures herein show an arrangement for asymmetrical electrodes. However, implementations of the capping board as described herein can be adapted to a capping board including a main elongated body and an additional insulating body configured to cooperate with a symmetrical electrode arrangement.

For example, the contact bar can be provided as multiple contact bar segments and the central channel can be configured to receive a single row of the contact bar segments. Additionally, the capping board can be adapted to receive one or more contact bar elements arranged in a parallel relationship. For example, the capping board can be adapted to cooperate with a primary contact bar and a secondary contact element which are supplied with two different electric power sources. The primary contact bar may contact anodes and the secondary contact bar may contact cathodes, or vice versa. Electrolytic cells including three or more contact bars may also be used. The capping board implementations described herein can be adapted to configurations of contact bar as described in patent documents U.S. Pat. Nos. 9,234,287, 10,000,857, 9,222,184 and 10,689,772.

Meanings of technical and scientific terms used herein are to be commonly understood as by one of ordinary skill in the art to which the invention belongs, unless otherwise defined.

It should be noted that the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only. Therefore, the descriptions, examples, methods and materials presented herein are not to be construed as limiting but rather as illustrative only.

In the present description, an implementation/embodiment is an example of the invention. The various appearances of “one embodiment,” “an embodiment”, “some embodiments” or “some implementations” do not necessarily all refer to the same implementation. Although various features of the invention may be described in the context of a single embodiment, the features may also be provided separately or in any suitable combination. Conversely, although the invention may be described herein in the context of separate implementations for clarity, the invention may also be implemented in a single embodiment.

It is to be understood that where the specification states that a component, feature, structure, or characteristic “may”, “might”, “can” or “could” be included, that particular component, feature, structure, or characteristic is not required to be included.

Any publications, including patents, patent applications, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

1. A capping board configured for use with a contact bar lying on the capping board for electrorefining of metals in two adjacent electrolytic cells, the capping board comprising a main elongated body made of an electrically insulating material having:
a plurality of seats projecting upwardly and being distributed along side portions of the main elongated body in two opposed rows to define:
a central portion extending in a longitudinal direction of the main elongated body between the two rows of seats, and
multiple lateral portions extending in a transverse direction of the main elongated body in between seats of a same row; and
side wall portions projecting upwardly between seats of a same row and from side edges of the main elongated body, wherein the side wall portions prevent metal dust that is generated by the contact bar from being communicated to the adjacent electrolytic cells via the lateral portions.

2. The capping board of claim 1, further comprising a pair of gutters, each gutter being a recess extending along and below a side of the central portion of the main elongated body between the two rows of seats, to guide rinsing water away from the capping board.

3. The capping board of claim 2, wherein each gutter has a depth that varies in the longitudinal direction to create a slope towards at least one end portion of the capping board.

4. The capping board of claim 3, wherein the depth of each gutter increases from a middle of the capping board to each end portion of the capping board to create a tapered bottom surface for each gutter.

5. The capping board of claim 3, wherein the depth of each gutter increases from a proximal end portion to a distal end portion of the capping board to create a downwardly inclined bottom surface for each gutter.

6. The capping board of claim 2, wherein each of multiple lateral portions of the main elongated body are sloped towards the corresponding gutter to guide the water from the side wall portions, along the lateral portions and to the gutter.

7. The capping board of claim 2, further comprising a water bridge component extending from the gutters of the main elongated body to guide the rinsing water across a side wall of the electrolytic cells to a dedicate collection area.

8. The capping board of claim 7, wherein the water bridge component comprises one water bridge collecting the rinsing water being evacuated from the gutter and directing the evacuated rinsing water to the dedicated collection area.

9. The capping board of claim 7, wherein the water bridge component comprises a pair of water bridges, each water bridge collecting the rinsing water being evacuated from one corresponding gutter and directing the evacuated rinsing water to the dedicated collection area.

10. The capping board of claim 1, further comprising a plurality of longitudinal wall segments distributed as two opposed inner rows and projecting upwardly from each side of the central portion of the main elongated body to provide abutment for the contact bar when lying on the central portion.

11. The capping board of claim 10, further comprising a groove defined in the central portion of the main elongated body and along a base of each longitudinal wall segment to facilitate flowing of the rinsing water from the central portion towards the corresponding longitudinal gutter.

12. The capping board of claim 1, further comprising reinforcement elements that are embedded in the main elongated body.

13. The capping board of claim 12, wherein the reinforcement elements are made of pultruded material.

14. A system for the electrorefining of metal in two adjacent electrolytic cells, the system comprising:
a capping board as defined in claim 1;
a contact bar lying on the central portion of the capping board;
multiple electrodes comprising an electrode plate and a pair of hanging bars extending from each upper side of the electrode plate, with the hanging bars being sized to be alternately received on the contact bar or on one corresponding seat of the capping board;
a source of water to provide a flow of water to the central portion and the lateral portions of the capping board to form rinsing water comprising metal dust; and
a dedicated collection area comprising a collection tank sized to receive the rinsing water being evacuated from the capping board.

15. The system of claim 14, wherein the contact bar is provided as multiple contact bar segments and the central channel of the caping board can be configured to receive at least one row of the contact bar segments.

16. The system of claim 14, wherein the contact bar is a primary contact bar and the capping board has the central channel that is configured to receive the primary contact bar, and the system further comprises an additional insulating body and at least one additional contact element, with the additional insulating body and the at least one additional contact element being configured to cooperate with a symmetrical electrode arrangement.
